(19) United States
(12) Patent Application Publication
(10) Pub. No.: US 2014/0325905 A1
(43) Pub. Date: Nov. 6, 2014

(54) Plant Pot Arrangement With an Outer Pot and an Insert Pot which can be Inserted into and Removed from the Outer Pot

(71) Applicant: Stanislav Novotny, Praha (CZ)

(72) Inventor: Stanislav Novotny, Praha (CZ)

(21) Appl. No.: 14/342,540

(22) PCT Filed: Sep. 4, 2012
(86) PCT No.: PCT/EP2012/003685

§ 371 Date: Jul. 3, 2014

(30) Foreign Application Priority Data
Sep. 5, 2011 (EP) 11180023.1

(51) Int. Cl. A01G 9/02

(52) U.S. Cl. CPC A01G 9/02
USPC 47/65.5

(57) ABSTRACT

Plant pot system, having an outer pot and inner pot insertable into outer pot and removable from outer pot, for holding a plant with planting soil. Inserting and removing inner pot is possible without handles; after insertion, no grasping by hand is necessary, and an attractive plant pot system is created because inner pot has diagonally arranged handling recesses in its top that are open toward top; inner pot is suspended from a supporting frame thrust from underside inner pot; after inserted into outer pot, inner pot stands on base of outer pot, and the suspended position of inner pot is undone by lowering supporting frame into a lower position on inner pot, and supporting frame can be placed on top of outer pot. Supporting frame is grasped via handling recesses of outer pot, and inner pot is removed from outer pot after supporting frame is put in suspended position.

### CROSS-REFERENCE TO RELATED APPLICATION

This application is a national stage patent application that claims the benefit of the priority filing date in PCT/EP2012/003685 and referenced in WIPO Publication No. WO2013/034274 filed on Sep. 4, 2012. The earliest priority date claimed is Sep. 5, 2011.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention relates to a plant pot system, having an outer pot and an inner pot that can be inserted into and removed from the outer pot, as defined by the preamble to claim 1.

From U.S. Pat. No. 7,886,484 B1, a plant pot system is known in which the plant pot in its upper, outer region has an integrally formed-on encircling rib on which a frame-like part can be placed. This part protrudes past the plant pot and forms support faces for an annular closure part, which is braced on the annular upper edge of the plant pot and on an outer rib of the frame-like part. Thus a closed, rounded closure at the top of the plant pot is attained, which has a robust construction. However, in this known plant pot system, there is no provision for inserting an inner pot into the plant pot and removing it.

US Patent Application 2010/0077660 A1 shows a plant pot which is provided at the top with an encircling, protruding rim on which the rim of a pot-like insert is braced by a different rim. This insert has a low height and after its removal from the plant pot, it can be used as a saucer for the plant pot. Moreover, the insert can be of various sizes and can itself be used as a plant pot.

Finally, German Patent Disclosure DE 195 15 700 A1 shows a device for holding planting soil that has a rectangular wooden receptacle. The side-walls of this wooden box can have longitudinally oriented outer ribs on the inside or outside, and on these ribs, a plastic insert with outer or inner ribs is braced. The plastic planting insert can also be braced on the tops of the wooden box. Instead of the supporting ribs, the side-walls of the wooden box can also have support recesses machined into them. As a rule, the insert has a height that is less than the height of the wooden box. The device avoids the risk of damage to the plastic insert and the ensuing rotting of the wood as well as the presence of standing water. However, this known device likewise lacks devices for easily manipulating the plastic insert as it is being removed from the wooden box.

A plant pot system with a plant pot and an inner pot of the type mentioned at the outset is known from European Patent Disclosure EP 1 790 212 B1. In this known plant pot system, the inner pot is provided, in the vicinity of the upper rim of the container, with diagonally arranged handles that are guided in handle guides and that can be adjusted into an insertion position that is flush with the outer pot and a removal position in which it protrudes from the outer pot. The handles can be grasped in the removal position and the inner pot can be removed from the outer pot. Inserting the inner pot into the outer pot is also done with the handles put in the removal position. After that, the handles are retracted into the insertion position, so that the plant pot system, without the protruding handles, makes a good impression visually and from a design standpoint.

The prerequisite for this is a complicated structural design of the inner pot and additional handles upon insertion and removal of the inner pot.

It is the object of the invention to develop a plant pot system which, without adjustable handles, makes it possible to insert and remove the inner pot and, after the insertion of the inner pot into the outer pot, avoids the need for additional grasping, and with which, after the insertion of the inner pot into the outer pot, a visually attractive construction automatically results.

This object is attained by the features of claim 1.

### SUMMARY

The invention relates to a plant pot system, having an outer pot and an inner pot that can be inserted into and removed from the outer pot. The outer pot has handling recesses that are arranged diagonally in the vicinity of the top. The inner pot is suspended from a supporting frame. After being placed in the outer pot, the inner pot stands on the base of the outer pot, and the suspended position of the inner pot can be undone by lowering the supporting frame into a lower position, and the supporting frame can be placed on the top of the outer pot. The supporting frame can be grasped via the handling recesses in the outer pot. After the supporting frame has been put in the suspended position, the inner pot can be removed from the outer pot.

With the supporting frame, the inner pot can be conveniently inserted into the outer pot. Once the inner pot has been inserted, the supporting frame can leave the suspended position. It can be lowered and placed onto the top of the outer pot. The supporting frame can be stopped at arbitrary points without a person's hands being pinched between the supporting frame and the top of the outer pot. Once the supporting frame is released from the person's hands, the supporting frame drops by its own weight onto the top of the outer pot and thereby automatically establishes the visual impression of the plant pot system.

Further advantageous embodiments of the plant pot system can be learned from the dependent claims.

So that the supporting frame can be fixed in the vicinity of the top of the inner pot, a further refinement provides that the supporting frame is limitedly vertically adjustable in the vicinity of the top of the inner pot by means of a covering and retention frame that can be connected to the supporting frame from the top of the inner pot.

In this way, the unit comprising the supporting frame and the covering and retention frame is fixed on the inner pot, which makes the plant pot system easier to use.

The vertical displacement motion of the supporting frame with the covering and retention frame is limited to at least the size of a hand introduced between this unit and the top of the outer pot.

The outer pot, the inner pot, the supporting frame and the covering and retention frame have a round, square, rectangular or oval cross section, and the individual cross sections are adapted to one another.

On its base, the inner pot has integrally formed-on spacers, which protrude from the inside of the base of the outer pot and define the adjustment position of the inner pot.

The supporting frame has a groove open at the top, into which a downward-pointing rib of the inner pot protrudes, and the suspended position of the inner pot in the supporting frame with the covering and retention frame is fixed by the contact of the rib with the groove.

In the suspended position, the supporting frame with the covering and retention frame is fixed relative to the top of the inner pot in the upper position of the supporting frame with the covering and retention frame.

When the inner pot has been placed on the base of the outer pot, the supporting frame with the covering and retention frame can be lowered into the lower position relative to the inner pot, and the supporting frame and/or the covering and retention frame is braced on the upper face end of the outer pot or on an inner shoulder of the inner pot.

The covering and retention frame, which covers the top of the plant pot system and fixes the hold of the unit comprising the supporting frame and the covering and retention frame on the inner pot, is latched onto the supporting frame.

### DRAWINGS

The invention will be described in further detail in terms of an exemplary embodiment shown in the drawings. In the drawings:

FIG. 1 is a side view of the plant pot system, with the upper region shown in section;

FIG. 2 is a fragmentary section along the line II-II of FIG. 1;

FIG. 3 shows the region, marked in FIG. 2 by the circle III, of the plant pot system in the inserted position of the inner pot; and

FIG. 4 shows the components corresponding to FIG. 3, in the suspended position of the inner pot and the hand upon reaching the adjustment position of the inner pot in the outer pot.

### DESCRIPTION

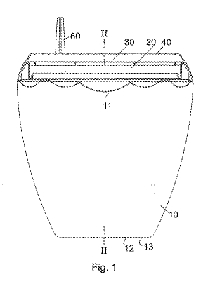

From FIG. 1, a plant pot system can be seen, with a round cross section of the outer pot 10, the inner pot 20, the supporting frame 30, and the covering and retention frame 40. In the vicinity of the top, the view is shown in fragmentary section, so that the individual components can be identified. The base 12 of the outer pot 10 has feet 13 that are formed integrally onto the outside. Reference numeral 11 identifies one of the diametrically arranged handling recesses, which are open toward the top in the top of the outer pot 10.

A fill level indicator 60 protrudes from the top of the plant pot system; it protrudes into a guide on the inner pot 10 as far as the vicinity between the base 12 of the outer pot 10 and the base 21 of the inner pot 20 and indicates the level of liquid.

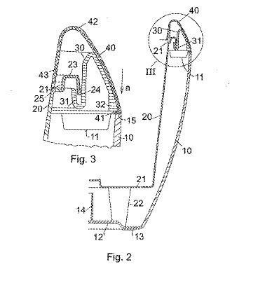

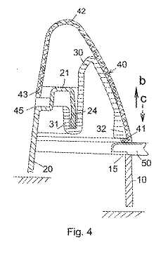

As FIG. 2 shows, the inner pot 20 stands on the inside of the base 12 of the outer pot 10, by way of spacers 22 formed onto the base 21. The region identified by the circle III in FIG. 2 is shown enlarged in FIG. 3. In the vicinity of the top of the inner pot 10, a unit comprising the supporting frame 30 and the covering and retention frame 40 is fixed in a limitedly vertically adjustable manner. The supporting frame 30 is thrust from below onto the inner pot 20, while the covering and retention frame 40 is connected from above, preferably in detent-locking fashion, to the supporting frame 30. The inner pot 20 has an inner shoulder 25, which changes over via a vertical leg 21 and a horizontal leg 23 into a downward-pointing rib 24. The rib 24 is inserted into a groove 31, open toward the top, of the supporting frame 30. The supporting frame 30 is connected by its outer leg 30 to the outer leg 42 of the covering and retention frame 40, preferably being detent-locked, as the detent elements 41 indicate. The inner leg 43 of the covering and retention frame 40 is braced on the inner shoulder 25 of the inner pot 20. This lower position of the components is automatically established when the inner pot 20 has been placed in the outer pot 10. It can also be seen from FIG. 3 that the suspended position of the inner pot 20 in the supporting frame 30 has been undone. As the arrow a shows, the position of FIG. 3 is dictated by the weight of the unit itself comprising the supporting frame 30 and the covering and retention frame 40 and is automatically established once the adjustment of the inner pot 20 in the outer pot 10 has been reached.

It can be seen from FIG. 4 that the suspended position of the inner pot 20 in the unit comprising the supporting frame 30 and the covering and retention frame 40 exists in the upper adjustment of the unit relative to the inner pot 20. The corresponding position of the inner pot 20 and outer pot 10 is predetermined then. This means that the unit comprising the inner pot 20 and the outer pot 10 allows the unit to be grasped at any arbitrary point, without a person's hand 50 being pinched between the outer leg 41 of the covering and retention frame 40 and the top 15 of the outer pot 10. The unit comprising the supporting frame 30 and the covering and retention frame 40, adjusted in the direction of the arrow 6, leaves sufficient space for the hand 50 that is grasping the unit. If the hand 50 releases the unit comprising the supporting frame 30 and the covering and retention frame 40, then the unit drops downward, as the arrow c indicates, until finally it assumes the lower position shown in FIG. 3. This happens automatically by the weight of the unit itself.

In the position of FIG. 3, the handling recesses 11 that are open at the top remain free for the introduction of a person's hands. The unit is lifted and assumes the suspended position of FIG. 4. With the unit comprising the supporting frame 30 and the covering and retention frame 40, the inner pot 20 can be removed from the outer pot 10 after being adjusted into the suspended position.

The outer pot 10 can have a greater wall thickness than the insert 20, the supporting frame 30, and the covering and retention frame 40.

1. A plant pot system, having an outer pot (10) and an inner pot (20) that is insertable into the outer pot (10) and removable from the outer pot (10), for holding a plant with planting soil, the outer pot (10) and the inner pot (20) being embodied as open at the top, wherein:
the outer pot (10) has handling recesses (11) in the vicinity of the top;
the inner pot (20) can be suspended from a supporting frame (30);
the inner pot (20), after insertion into the outer pot (10), stands on a base (12) of the outer pot (10), and the suspended position of the inner pot (10) can be undone by lowering the supporting frame (30) into a lower position on the inner pot (20), and the supporting frame (30) can be placed on the top of the outer pot (10); and
the supporting frame (30) can be grasped via the handling recesses (11) of the outer pot (10), and the inner pot (20) is removable from the outer pot (10) after the supporting frame (30) has been put in the suspended position.

2. The plant pot system of claim 1, wherein the supporting frame (30) is vertically adjustable to a limited extent in the vicinity of the top of the inner pot (20) by means of a covering and retention frame (40), which is connectable to the supporting frame (30) from the top of the inner pot (20).

3. The plant pot system of claim 2, wherein the vertical displacement motion of the supporting frame (30) with the covering and retention frame (40), all comprising a unit, is limited to at least the size of a hand (50) introduced between this unit and the top of the outer pot (10).

4. The plant pot system of one of claim 1, wherein the outer pot (10), the inner pot (20), the supporting frame (30), and the covering and retention frame (40) have a round, square, rectangular or oval cross section, and these individual cross sections are adapted to one another.

5. The plant pot system of claim 1, wherein the inner pot (20) has spacers (22), integrally formed onto the outer base (21), which stand on the inside of the base (12) of the outer pot (10) and define the adjustment position of the inner pot (10) in the outer pot (10).

6. The plant pot system of claim 1, wherein the supporting frame (30) has a groove (31), open at the top, into which a downward-pointing rib (24) of the inner pot (20) protrudes; and the upper suspended position of the inner pot (20) in the supporting frame (30) with the covering and retention frame (40) is defined by the contact of the rib (24) with the groove.

7. The plant pot system of claim 6, wherein, the suspended position of the inner pot (20) in the unit comprising the supporting frame (30) and the covering and retention frame (40) exists in the upper adjustment of the unit relative to the inner pot (20).

8. The plant pot system of one of claim 1, wherein, when the inner pot (20) is placed on the base (12) of the outer pot (10), the supporting frame (30) with the covering and retention frame (40) can be lowered into a lower position relative to the inner pot (20), in which the supporting frame (30) and/or the covering and retention frame (40) is braced on the upper face of the outer pot (10) or on an inner shoulder (45) of the inner pot (20).

9. The plant pot system of claim 1, wherein the outer pot (10), the inner pot (20), the supporting frame (30) and the covering and retention frame (40) are made of plastic, and the outer pot (10) has a greater wall thickness.

10. The plant pot system of claim 2, wherein the covering and retention frame (40) is latched onto the supporting frame (30).
